(19) United States
(12) Patent Application Publication
(10) Pub. No.: US 2003/0103223 A1
(43) Pub. Date: Jun. 5, 2003

(54) Apparatus and method for accessing data recording paper

(76) Inventor: Ching-Chung Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/340,801

(22) Filed: Jan. 13, 2003

Related U.S. Application Data
(63) Continuation-in-part of application No. 09/342,204, filed on Jun. 29, 1999.

(51) Int. Cl. B41J 1/00; G06F 15/00

(52) U.S. Cl. 358/1.12; 358/1.14

(57) ABSTRACT

An apparatus and method for accessing data recording paper are proposed. Therein, the apparatus comprises a data recording paper having a digital data recorded thereon, a color scanner, a printer, a computer and a monitor. The digital data is encoded by the brightness and color variation of the data marks. The digital data recorded on the paper can be accessed or executed in the computer via the scanning of the color scanner and the processing of an internal control program of the computer. Moreover, by this way, the digital data also can be displayed on a monitor of the computer or printed by a printer.

### CROSS REFERENCE TO RELATED APPLICATION

This application is a continuation-in-part of U.S. application Ser. No. 09/342,204, filed on Jun. 29, 1999 and entitled “Paper type computer data accessing device”.

### FIELD OF THE INVENTION

The present invention relates to an apparatus and method for accessing data recording paper, especially to an apparatus and method that can directly access data from a paper having digital data recorded thereon.

### BACKGROUND OF THE INVENTION

The current accessing devices for digital data usually use CDR (Compact Disk-Recordable) to access audio data, video data or application programs. However, the conventional recording medium for digital data involves blank CDR, which has considerable price (about 0.25 US dollar for one piece of blank CDR).

Moreover, the recordable area of the CDR is small and its recording density is relative low due to the digital data only being recorded by dull marks, rather than colored marks. Therefore, the capacity of the CDR is limited.

Besides, the material of the CDR is hard and unbending. If one would like to attach the CDR to a book or magazine as a gift, the CDR will need an additional protection for preventing it from damage.

Accordingly, as discussed above, the accessing devices and media obviously still have some drawbacks that could be improved. The present invention aims to resolve the drawbacks in the prior art.

The present invention is intended to provide an apparatus and method for accessing data recording paper, which can uses a common paper and printer to record digital data and can access the digital data by using a color scanner and an internal control program of a computer.

### SUMMARY OF THE INVENTION

The object of the present invention is to provide an apparatus and method for accessing data recording paper that use the brightness and color variation of colored marks to record digital data on a common paper.

Another object of the present invention is to employ a color scanner and an internal control program to access the digital data recorded on a data recording paper.

Also another object of the present invention is to use colored marks to record the digital data on a common paper via a printer.

Still another object of the present invention is to provide a cheaper medium for storing data by using the blank paper instead of the blank CDR.

Also still another object of the present invention is to provide a data recording medium, which uses a high density recording paper and colored marks to record digital data so as to have larger data capacity than the CDR.

The various objects and advantages of the present invention will be more readily understood from the following detailed description when read in conjunction with the appended drawing.

### BRIEF DESCRIPTION OF DRAWING

FIG. 1 shows the schematic diagram of the present invention.

FIG. 2A shows a sheet of data recording paper complied with the present invention.

FIG. 2B shows a text file accessed from the data recording paper.

FIG. 3 shows that a scanned image data possibly has a problem of deflection.

FIG. 4 shows an operation flow chart of the internal program for opening an image file complied with the present invention.

FIG. 5 shows an operation flow chart of the internal program for printing an chosen file in accordance with the present invention.

### DETAIL DESCRIPTION OF PREFERRED EMBODIMENT

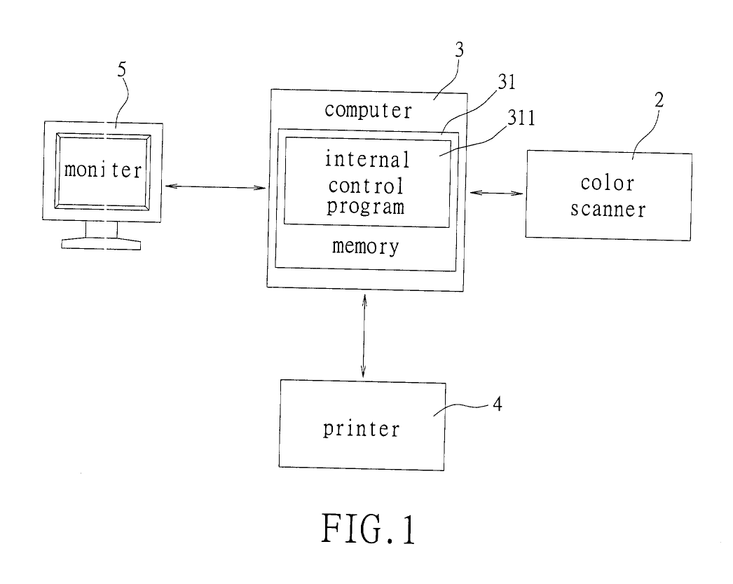

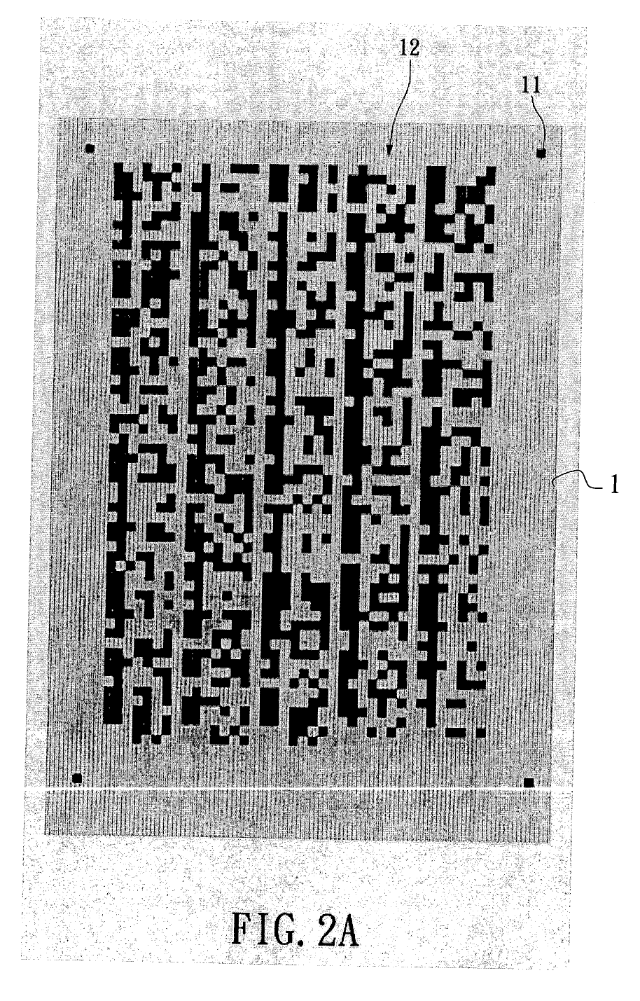

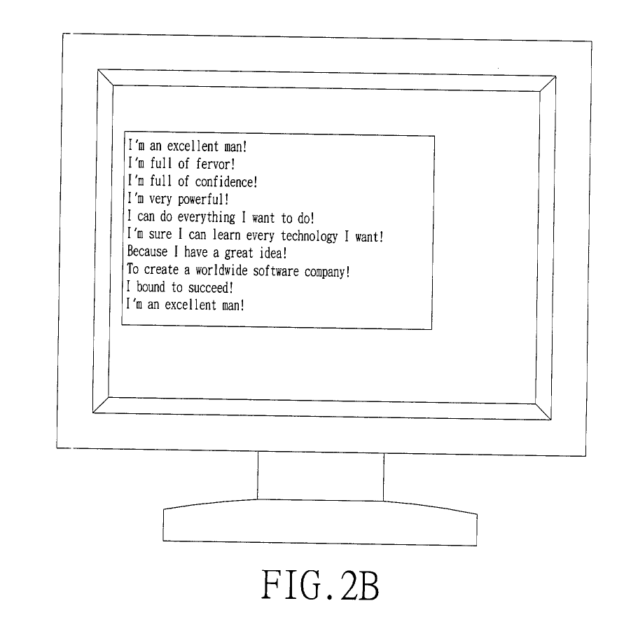

As shown in FIGS. 1 and 2A, the apparatus for accessing data recording paper according to the present invention comprises a data recording paper 1, a color scanner 2, a computer 3, a printer 4 and a monitor 5.

The data recording paper 1 further comprises data marks 11 and reference marks 12. The data marks 11 of the data recording paper 1 are used to record a digital data. And, the reference marks 12 are used for the deflection adjustment of the scanned image data of the data recording paper 1.

In this embodiment, the data marks 11 only comprise white marks and black marks. However, in practice, the digital data can be recorded via the brightness and color variation of colored marks.

Moreover, the size of the data recording paper 1 can be, for example, A4 (210 mm×297 mm or 8.5″×11.7″), or A3. In the former case, if the data marks 11 is colored, the data storage capacity can reach 3.336 GBytes, i.e., (8.5″×11.7″)×(2400 DPI)²×3(RBG)×8 bits(brightness)×2(two sides) 3.336 GBytes. Therefore, the capacity of the data recording paper 1 is much larger than common CDR.

The color scanner 2 is used to scan the data marks 11 and reference marks recorded on the data recording paper 1 so as to access the digital data.

The computer 3 is connected to the color scanner 2 and the printer 4 through the USB (Universal Serial Bus), SCSI (Small Computer System Interface) and EPP (Enhanced Parallel Port), respectively.

The computer 3 further comprises a memory 31, which has an internal control program 311 stored therein. The internal control program 311 is adapted to access the output image data from the color scanner 2, and perform the deflection adjustment (shift or rotation adjustment), and color compensation of the image data. Moreover, the internal control program 311 of the computer 3 also can control the printer 4 to record digital data on a paper.

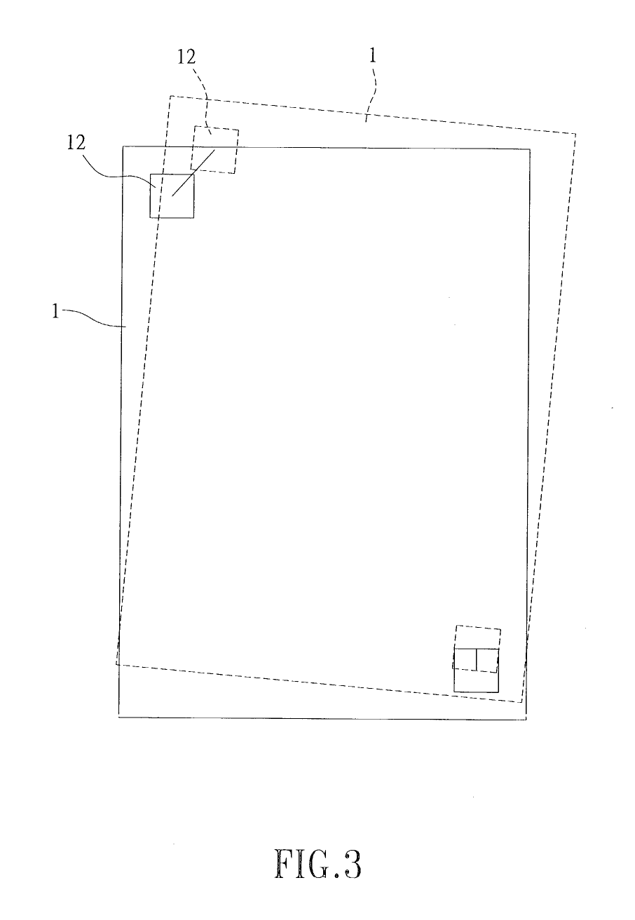

As shown in FIG. 3, the scanned image data possibly has a problem of deflection. Therefore, the internal control program 311 of the computer 3 will use the reference marks 12 to calculate the deflected coordinate value of the image data with following formula:

x′=x cos φ+y sin φ

y′=−x sin φ+yconφ

wherein φ is the deflection (rotation) angle; x and y are the original coordinate value of the x-axis and y-axis of the image data, respectively; x′ and y′ are the deflected coordinate value of the x-axis and y-axis, respectively.

By using above formula, the internal control program 311 can adjust the deflection of the image data of the data recording paper 1 so as to correctly display the image data on the monitor 5.

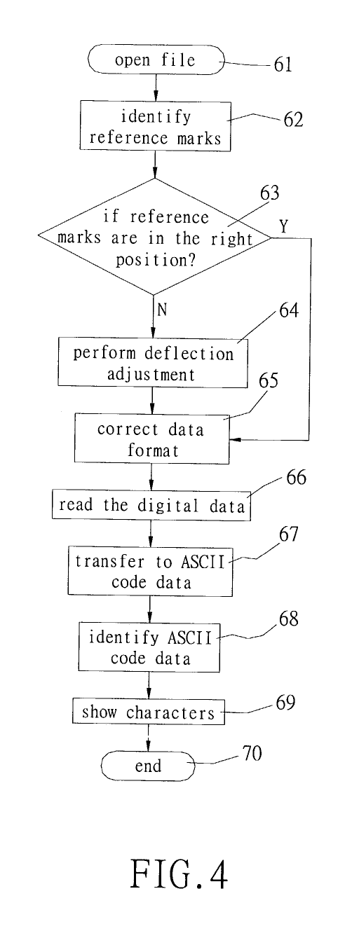

Please refer to FIG. 4, which is an operation flow chart of the internal program 311 for opening an image file having the image data of the data recording paper 1. Please note that the digital data recorded in the data recording paper 1 of this embodiment is about some English sentences. However, in practice, the digital data of the data recording paper 1 can be any kind of data, e.g., audio, video, text and program, etc.

The operational steps of the embodiment are described as following:

Step 61: Initially, the internal control program 311 will open an image file chosen by the user. In this embodiment, the image file is stored in tag image file format (TIFF).

Step 62: After the image file is opened, the internal control program 311 will identify the reference marks 12.

Step 63: Then, the internal control program 311 will determine if the reference marks are in the right positions. If yes, jump to step 65. Otherwise, go to step 64.

Step 64: Since deflection of the image data, the internal control program 311 will use the reference marks 12 to calculate the deflected coordinate value of the image data by the formula described above so as to perform the deflection adjustment of the image data. Then, go to Step 65.

Step 65: In this step, the internal control program 311 will perform the correcting of the data format, which comprises the correcting of the white reference, black reference and color threshold, for the color compensation of the image data. In practice, the operation of this step can be performed by a general software of the color scanner.

Step 66: Then, the internal control program 311 will start to read the digital data recorded in the image data. In this step, the digital data has already been accessed by the computer 3. However, in this embodiment, the digital data is corresponding to some English sentences so that the internal control program 311 will continue executing the following steps to transfer the digital data to the text.

Step 67: After the digital data is accessed, the internal control program 311 will first transfer the digital data into ASCII code (American Standard Code for Information Interchange) data.

Step 68: Then, the internal control program 311 will identify the ASCII code data and transfer the ASCII code into characters.

Step 69: Finally, the internal control program 311 will show the characters on the monitor 5 of the computer 3. In this step, the user can read the English sentences recorded in the data recording paper 1 as shown in FIG. 2B.

Step 70: End the accessing operation.

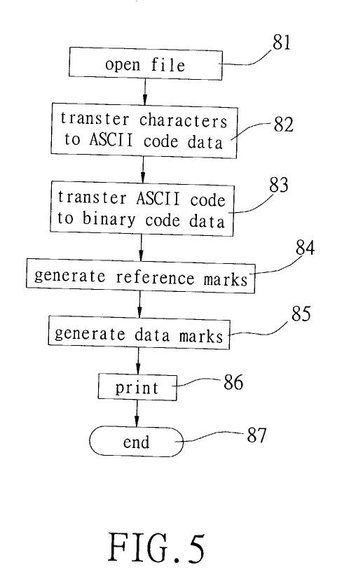

Please refer to the FIG. 5, which is an operation flow chart of the internal control program 311 for printing a file stored in the computer 3 by the print 4 in accordance with the present invention. Please note that the content of the file of this embodiment is also corresponding to some English sentences. However, in practice, the content of the file can be any kind of data, e.g., audio, video, text and program, etc.

The operational steps of the embodiment are described as following:

Step 81: Initially, the internal control program 311 will open a file chosen by the user.

Step 82: After the file is opened, the internal control program 311 will first transfer the characters of the English sentences in the file into ASCII code data.

Step 83: Then the internal control program 311 will transfer the ASCII code of the characters into binary code data.

Step 84: After the code transferring is completed, the internal control program 311 will generate the reference marks 12 of an image.

Step 85: Then, the internal control program 311 will generate the data marks 11 of the image in accordance with the binary code data of the characters.

Step 86: Finally, the internal control program 311 will use the printer 4 to print the image on a paper.

Step 87: End the printing operation.

To sum up, the invention provides an apparatus and method for accessing data recording paper, which uses a color scanner and internal control program of a computer to access digital data recorded on a data recording paper, thus provides the accessing device with cheaper recording medium.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. An apparatus for accessing data recording paper comprising
a data recording paper having digital data recorded thereon, the digital data being recorded by brightness and color variation of data marks;
a color scanner for scanning the data recording paper so as to generate an image data; and
a computer connected to the color scanner and adapted to access the image data outputted from the color scanner, the computer being controlled by an internal control program to adjust a displacement and a rotation of the image data, or compensate a color of the image data and then access the digital data from the image data.

2. The apparatus as in claim 1, wherein the data marks comprises white marks and black marks.

3. The apparatus as in claim 1, wherein the digital data is a text, audio data, video data or program.

4. The apparatus as in claim 1, wherein the data recording paper further comprises reference marks for adjusting the displacement and rotation of the image data.

5. The apparatus as in claim 1, wherein the paper size of the data recording paper is 210 mm×297 mm.

6. The apparatus as in claim 1, wherein the paper size of the data recording paper is A3.

7. The apparatus as in claim 1, wherein the computer is connected to a printer for recording a digital data encoded by the data marks on a paper.

8. The apparatus as in claim 7, wherein the paper further comprises reference marks recorded thereon.

9. A data recording medium comprising:
a sheet of paper;
a plurality of colored data marks; and
a plurality of reference marks;
wherein the colored data marks and reference marks are recorded on the paper, brightness and color variation of the colored data marks are used to encode a digital data so as to record the digital data on the paper, the reference marks are used to adjust a displacement and rotation of a image data of the paper as the digital data recorded on the paper is accessed by a computer.

10. The data recording medium as claimed in claim 9, wherein the colored data marks comprise white marks and black marks.

11. The data recording medium as claimed in claim 9, wherein the computer is connected with a color scanner for accessing the digital data recorded on the paper.

12. The data recording medium as claimed in claim 9, wherein the computer is controlled by an internal control program to access the digital data from the paper and adjust the displacement and rotation of the paper, or compensate a color of the paper.

13. A method for accessing data recording paper comprising:
opening an image file via an internal control program of a computer;
identifying reference marks recorded in the image file by the internal control program;
correcting a data format of the image file by the internal control program; and
reading digital data recorded in the image file by the internal control program;
wherein the image file is accessed by a color scanner connected with the computer, the image file further has colored data marks recorded therein, and the digital data is encoded by a brightness and color variation of the colored data marks.

14. The method as claimed in claim 13, wherein a content of the digital data is text and after reading the digital data recorded in the image file by the internal control program the method further comprises:
transferring the digital data into ASCII code (American Standard Code for Information Interchange) data by the internal control program;
identifying the ASCII code data and transferring the ASCII code data into characters by the internal control program; and
showing the characters on a monitor of the computer.

15. The method as claimed in claim 13, wherein a content of the digital data is audio data, video data or program.

16. The method as claimed in claim 13, wherein a step of performing a deflection adjustment of the image file by the internal control program is added between the step of identifying reference marks recorded in the image file by the internal control program and the step of correcting the data format of the image file by the internal control program.

17. A method for generating data recording paper comprising:
opening a file via an internal control program of a computer;
transferring a content of the file into binary code data by the internal control program;
generating reference marks of a image by the internal control program;
generating colored data marks of the image in accordance with the binary code data by the internal control program; and
printing the image on a paper by a printer connected with the computer;
wherein the binary code data is encoded by a brightness and color variation of the colored data marks.

18. The method as claimed in claim 17, wherein the file is a text file and the step of transferring the content of the file into the binary code data by the internal control program further comprises:
transferring characters in the text file into ASCII code data by the internal control program; and
transferring the ASCII code data into the binary code data by the internal control program.

19. The method as claimed in claim 17, wherein the file is a audio file, video file or program file.
